(19) United States
(12) Patent Application Publication
(10) Pub. No.: US 2026/0070381 A1
(43) Pub. Date: Mar. 12, 2026

(54) Simple and reliable electric trailer hitch

(71) Applicant: Zhejiang Normal University, Jinhua City (CN)

(72) Inventors: Ying DONG, Jinhua City (CN); Zhanhui CHANG, Jinhua City (CN)

(73) Assignee: Zhejiang Normal University, Jinhua City, ZJ (CN)

(21) Appl. No.: 19/392,020

(22) Filed: Nov. 17, 2025

(30) Foreign Application Priority Data
Mar. 12, 2025 (CN) 202510289746.7

(51) Int. Cl. B60D 1/24; B60D 1/54

(52) U.S. Cl. CPC B60D 1/246; B60D 1/54

(57) ABSTRACT

The present disclosure provides a simple and reliable electric trailer hitch, including a fixed member, a trailer hook, a driven member, and a driving member; the driving member is directly or indirectly connected to an actuating device, the driven member is connected to the trailer hook, and the driving member is configured to cooperate with the driven member to drive the driven member to rotate; the driving member includes a transmission part and a locking part, and the driven member includes a transmission part and a locking part; the transmission parts and the locking parts are configured in such a way that, the locking parts engage when the transmission parts are disengaged, and the transmission parts engage when the locking parts are disengaged. The electric trailer hitch of the present disclosure has an extremely simple structure, is easy to manufacture, and has high operational reliability.

### CROSS-REFERENCE TO RELATED APPLICATION

This application claims priority to Chinese Patent Application No. 202510289746.7, filed on Mar. 12, 2025, titled “Simple and reliable electric trailer hitch” before the China National Intellectual Property Administration, the disclosure of which is incorporated herein by reference in entirety.

### TECHNICAL FIELD

The present disclosure relates to the field of vehicle accessories, and in particular to a simple and reliable electric trailer hitch.

### BACKGROUND

A trailer hitch, also known as a drawbar, tow bar, or tow hook, is a device that connects a vehicle to other vehicle or equipment, primarily used in vehicle for towing other vehicles or goods. Trailer hitches include fixed trailer hitches and non-fixed trailer hitches. Fixed trailer hitches, due to their intended use, usually have a portion protruding from the vehicle, which affects the vehicle's aesthetics and safety.

To eliminate these effects, non-fixed trailer hitches have emerged, including detachable and foldable trailer hitches. When the trailer hitch has the capability of extension and retraction driven by a motor, it is called an electric trailer hitch. Specific structural design within the motor-driven mechanism ensure that the trailer hitch is reliably fixed in both the working and retracted positions, making it convenient to use and avoiding the negative effects of a constantly extended trailer hitch.

### SUMMARY

The objective of the present disclosure is to at least partially overcome the deficiencies of the prior art and provide a simple and reliable electric trailer hitch. Through a simple structure, the trailer hitch can be reliably fixed in the working position and the retracted position. Even under the action of external force, it can still maintain a stable position, and it can be smoothly rotated from one fixed position to another position and re-fixed.

To achieve the above-mentioned objectives or one of them, the technical solutions of the present disclosure are as follows:

An electric trailer hitch, comprising a fixed member, a trailer hook, a driven member, and a driving member;
the fixed member is fixedly installed on a vehicle body, the driving member is directly or indirectly connected to an actuating device, the driven member is connected to the trailer hook and installed on the fixed member; the driving member is configured to cooperate with the driven member and drive the driven member to rotate; the driving member comprises a transmission part and a locking part, the driven member comprises a transmission part and a locking part;
the transmission parts of the driving member and the driven member and the locking parts of the driving member and the driven member are configured in such a way that, the locking parts engage when the transmission parts are disengaged, and the transmission parts engage when the locking parts are disengaged.

According to some embodiments of the present disclosure, the driving member is an incomplete gear, the transmission part of the driving member is toothed part, and the locking part of the driving member is toothless part.

According to some embodiments of the present disclosure, the toothed part has a first tooth and/or a last tooth that has a tooth height less than a standard value.

According to some embodiments of the present disclosure, the driving member and the driven member are respectively provided with transmission guiding features, and the transmission guiding features are configured to facilitate smooth switching between an engagement of the transmission parts and an engagement of the locking parts.

According to some embodiments of the present disclosure, the transmission guiding features are configured to reduce impact when switching between the engagement of the transmission parts and the engagement of the locking parts.

According to some embodiments of the present disclosure, the transmission part and the locking part are located in the same plane.

According to some embodiments of the present disclosure, the transmission part and the locking part are located in different planes.

According to some embodiments of the present disclosure, the number of driving members is more than one, and the driving members are distributed circumferentially around the driven member.

According to some embodiments of the present disclosure, there are multiple driving members, which are evenly and circumferentially distributed around the driven member and cooperate simultaneously with the same actuating device.

The simple and reliable electric trailer hitch of the present disclosure has the following advantages:

It has a simple structure. The driving member is driven by an actuation device, and the driving member drives the driven member to achieve the working requirements. It has few parts, the parts are easy to process and manufacture, and the cost is low.

It is reliable in operation. The locking parts on the driving member and the driven member lock together in the working and retracted positions of the trailer hitch, so that the trailer hitch can be reliably positioned in these two positions to meet the working requirements.

It is easy to use. The drive rotation and locking are switched naturally without the need for additional action mechanisms or drive methods. By adding simple transmission guiding features, the dynamic characteristics of the driven member from rest to rotation can be effectively improved when it is driven to move

### BRIEF DESCRIPTION OF THE DRAWINGS

FIG. 1 is a schematic view of a simple and reliable electric trailer hook according to the embodiment 1 of the present disclosure;

FIG. 2 is a schematic view of a simple and reliable electric trailer hook according to the embodiment 2 of the present disclosure;

FIG. 3 is a schematic view of a simple and reliable electric trailer hook according to the embodiment 3 of the present disclosure;

FIG. 4 is a schematic view of a simple and reliable electric trailer hook according to the embodiment 4 of the present disclosure;

FIG. 5 is a schematic view of a simple and reliable electric trailer hook according to the embodiment 5 of the present disclosure;

FIG. 6 is a schematic view of a simple and reliable electric trailer hook according to the embodiment 6 of the present disclosure;

FIG. 7 is a schematic view of a simple and reliable electric trailer hook according to the embodiment 7 of the present disclosure.

### DETAILED DESCRIPTION OF EMBODIMENTS

Exemplary embodiments of the present disclosure are described in detail below with reference to the accompanying drawings, wherein the same or similar reference numerals denote the same or similar elements. Furthermore, in the following detailed description, numerous specific details are set forth for ease of explanation to provide a thorough understanding of the embodiments disclosed herein. However, it will be apparent that one or more embodiments may be practiced without these specific details. In other instances, well-known structures and apparatuses are illustrated in a simple way to simplify the drawings.

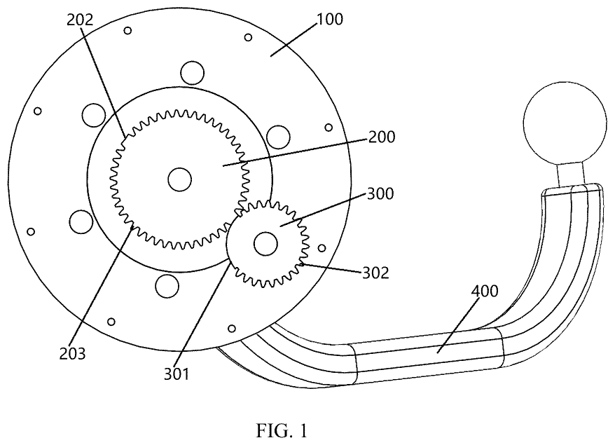

FIG. 1 is a schematic view of a simple and reliable electric trailer hitch of the present disclosure. As shown, the electric trailer hitch includes a fixed member 100 fixedly connected to a vehicle frame, a driven member 200 installed in the fixed member 100, a trailer hook 400 installed on the driven member 200, and a driving member 300 cooperating with the driven member 200. Herein, the fixed connection between the fixed member 100 and the vehicle frame or bumper is not shown. The trailer hook 400 is fixedly installed with the driven member 200, and the driving member 300 is installed on the fixed member 100 and can only rotate around a fixed axis. The driving member 300 is connected to an actuating device (for example, a motor, not shown) and rotates actively. The driving member 300 is an incomplete gear, including a transmission part 302 (i.e., a toothed part) and a locking part 301 (i.e., a toothless part). The driven member 200 is an incomplete gear, including transmission part 203 and locking part 202. In this embodiment, to ensure smooth operation and reduce impact, the tooth height of the initial/first tooth of the transmission part 302 of the driving member 300 is reduced. The locking part 301 is a toothless convex arc, with its center coinciding with the gear center. The locking part 202 of the driven member 200 is a toothless concave arc, matching the locking part 301, with its center coinciding with the gear center of the driving member 300. Specifically, when the initial tooth of the transmission part 302 of the driving member 300 engages, the endpoint of the engagement between the locking part 301 and the locking part 202 is on the center line of the driven member 200 and the driving member 300; when the final tooth of the transmission part 302 of the driving member 300 disengages, the starting point of the engagement between the locking part 301 and the locking part 202 is on the center line of the driven member 200 and the driving member 300. Importantly, by employing the aforementioned technical means, the driving member 300 and the driven member 200 are configured such that when the transmission part 302 disengages from the transmission part 203, the locking part 301 engages with the locking part 202; and when the locking part 301 disengages from the locking part 202, the transmission part 302 engages with the transmission part 203.

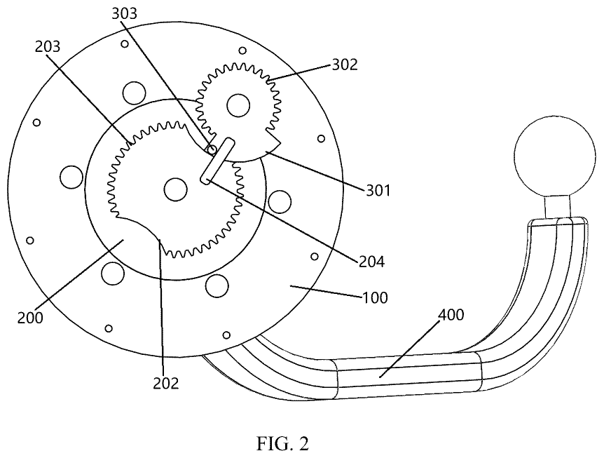

FIG. 2 shows another embodiment of the present disclosure. The difference from FIG. 1 is that the locking arc radius of the locking part 301 of the driving member 300 exceeds the addendum circle radius of the transmission part 302. Therefore, when the locking parts disengage, the transmission parts cannot engage. To ensure smooth operation, a transmission guiding feature 303 is added to the driving member 300, and a transmission guiding feature 204 is added to the driven member 200. When the locking parts disengage, the driving member 300 drives the driven member 200 to rotate via the transmission guiding features, thereby engaging the transmission parts. To ensure that the trailer hook 400 can be locked by the driving member 300 in both the working and retracted positions, and can be smoothly switched from the locked state to the transmission state, the driven member 200 has two locking parts 202, each equipped with a corresponding transmission guiding feature. The locking part 202 currently not engaged with the locking part 301 in the figure should also have a transmission guiding feature 204 added, which is not shown in the figure.

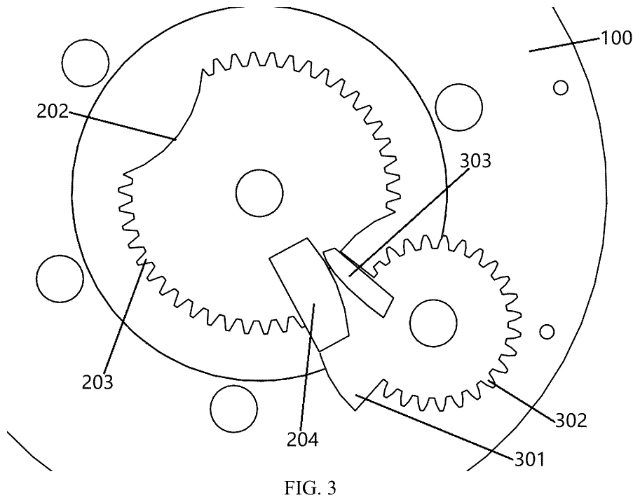

FIG. 3 shows another embodiment of the present disclosure, which differs from FIG. 2 in that the transmission guiding features are different. In the embodiment of FIG. 2, the transmission guiding features are respectively in the form of lever and pin, which can realize the transmission of action and smoothly switch between transmission engagement and locking engagement. During the switching process between transmission engagement and locking engagement, the action of the driven member 200 is a dynamic-static transformation, which involves a certain impact. In the embodiment of FIG. 3, the engagement structure of transmission guiding features 303 and 204 is an instantaneous center curve. When the shape of the instantaneous center curve is different, the motion characteristics of the driven member are also different during the process of contact to separation of the transmission guiding features. Optionally, the engagement curve of the transmission guiding features is an instantaneous center curve. Through the design of the instantaneous center curve, a smooth transition of the transmission ratio between the driving member and the driven member from zero to a fixed transmission ratio can be achieved, reducing or even eliminating speed abrupt changes and impacts, and obtaining better power transmission characteristics.

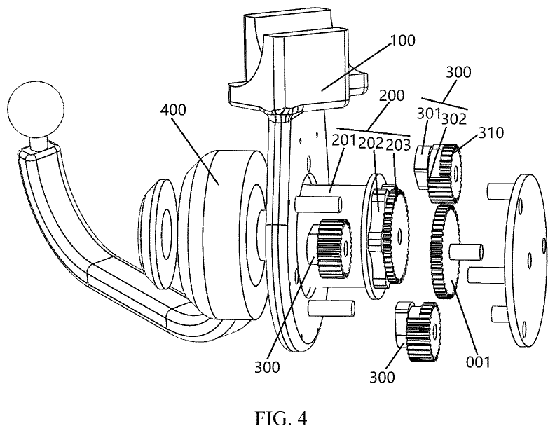

In the above embodiments, the driving member 300 adopts an incomplete gear, and the transmission part 302 and the locking part 301 are both on the same plane. Correspondingly, the driven member 200 also adopts an incomplete gear, and the transmission part 203 and the locking part 202 are also on the same plane. In the embodiment shown in FIG. 4, the driving member 300 is an incomplete gear, but the transmission part 302 and the locking part 301 belong to different planes. In the plane where the transmission part 302 is located, there are a toothed part for driving and a toothless part. The locking part 301 is located at the position corresponding to the toothless part, but on another plane. The driven member 200 includes a part 201 that cooperates with the fixed member 100, a transmission part 203 that cooperates with the transmission part 302, and a locking part 202 that cooperates with the locking part 301. As can be seen from the figure, the transmission part 203 can use a complete gear or an incomplete gear, depending on the specific application. A secondary transmission gear 310 is fixedly connected to the driving member 300. Optionally, the secondary transmission gear 310 and the transmission part (toothed part) 302 of the driving member 300 have the same module and it has the same total number of teeth as the driving member 300 if it's a complete gear, and they are integrally machined to reduce production costs. Optionally, there are three driving members 300, evenly distributed along the circumference of the driven member 200. The primary transmission gear 001 engages with the secondary transmission gear 310 and driven by the motor.

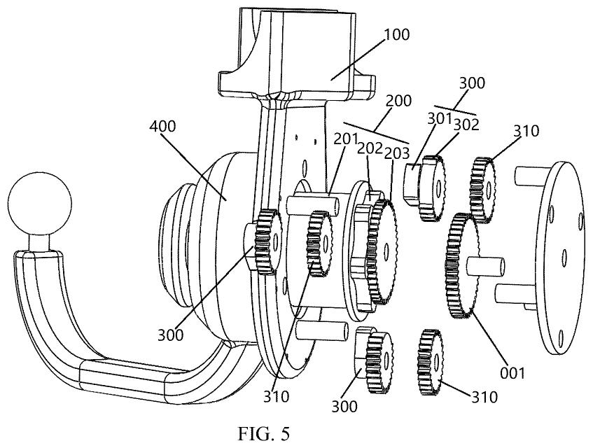

The embodiment shown in FIG. 5 is basically the same as that in FIG. 4, except that the number of teeth and module of the secondary transmission gear 310 are allowed to differ from the parameters of the toothed part of the driving member 300. This allows for greater freedom in the design of the transmission ratio of the driving member 300 and the actuation device, and more diverse selection of parameters for each gear. Specifically, the secondary transmission gear 310 can be machined separately, or machined as a single unit with different parameters, or the fixed connection between the secondary transmission gear 310 and the driving member 300 can be disassembled; multiple methods are possible.

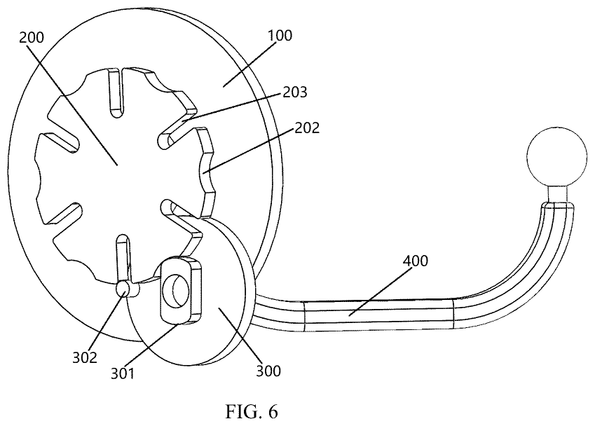

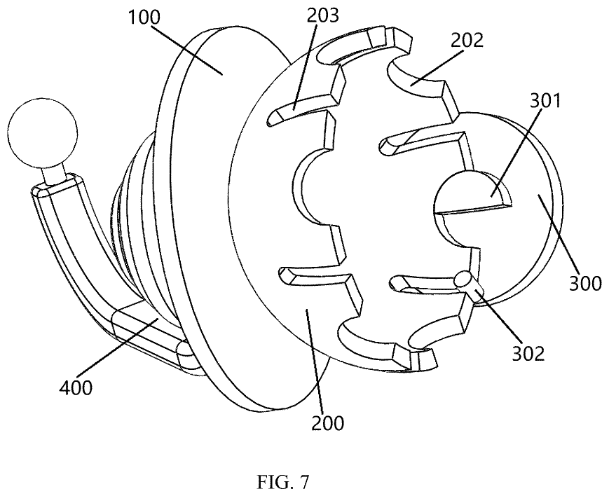

In the embodiments shown in FIGS. 1-5, the engagement between the driving member 300 and the driven member 200 employs an incomplete gear mechanism. In FIGS. 6 and 7, the engagement between the driving member 300 and the driven member 200 employs a groove wheel mechanism. FIG. 6 shows a planar groove wheel mechanism, and FIG. 7 shows a spatial groove wheel mechanism. Their structures and working principles are basically the same, and their mechanisms are also largely consistent with those of incomplete gear mechanisms. However, the groove wheel mechanism cannot achieve a 180-degree rotation in a single operation; therefore, the driving member 300 (i.e., a dial) needs to rotate multiple times to achieve one working process of the trailer hook.

The operation of the simple and reliable electric trailer hitch of the present disclosure is described below with reference to the embodiment shown in FIG. 4 or 5:

The fixed member 100 is fixedly connected to the vehicle frame, the trailer hook 400 is fixedly connected to the driven member 200, and the primary transmission gear 001 is connected to the motor and meshes/engages with the secondary transmission gear 310. The secondary transmission gear 310 is fixedly connected to the driving member 300, driving the driving member 300 to rotate together. Since the locking part and the transmission part are on different planes, it is ok that there is no design of reduced tooth height, and the absence of transmission guiding features is permissible. When the trailer hook 400 is in the retracted position, the transmission part 302 of the driving member 300 faces the transmission part 203 of the driven member 200 with its toothless part facing the transmission part 203 of the driven member 200, the locking part 301 of the driving member 300 locks into the locking part 202 of the driven member 200, making the driven member 200 locked, i.e., the trailer hook 400 is stably fixed in the retracted position and unable to move. When the motor rotates, it drives the driving member 300 to rotate via the primary transmission gear 001 and the secondary transmission gear 310, causing the trailer hook 400 to extend from the retracted position to the working position. During this process, when the locking part 301 of the driving member 300 disengages from the locking part 202 of the driven member 200, the transmission part 302 engages with the transmission part 203 until the trailer hook 400 rotates to the working position, which is 180 degrees in this embodiment. Then, the transmission part 302 of the driving member 300 disengages from the transmission part 203 of the driven member 200, while the locking part 301 engages with the locking part 202. Throughout the entire operation, the movement of the trailer hook 400 is completely under control, even in the working position and the retracted position, due to the gravity of the trailer hook 400 itself, the driven member 200 may rotate slightly due to machining precision and other reasons during the switching between transmission engagement and locking engagement, this still does not affect the switching process at all, and the entire operation can proceed normally.

The entire working process of the trailer hitch in FIGS. 6 and 7 is also achieved by directly or indirectly driving the driving member 300 through the actuation device. The transmission part 302 on the driving member 300 cooperates with the transmission part 203 on the driven member 200 to achieve transmission. The locking part 301 on the driving member 300 cooperates with the locking part 202 on the driven member 200 to achieve locking. When the transmission parts disengage, the locking parts engage; when the locking parts disengage, the transmission parts engage, thus completing the entire working process. The working process is basically the same as that of the above embodiment, and will not be described in detail here.

The simple and reliable electric trailer hitch of the present disclosure has the following advantages:

It has a simple structure and few parts, it can meet the requirements and achieve a complete working process in special cases by working with a pair of incomplete gears.

It is easy to process and has low cost. The transmission part, locking part and other structural features are common structures in the engineering field, such as gear, circular arc surface mechanism, straight groove, etc. It is extremely easy to process, with low difficulty and low cost.

The process is smooth and the operation is reliable. The incomplete gear mechanism or groove wheel mechanism can naturally meet the smooth switching between the transmission process and the locking process. At the moment the transmission stops, the locking mechanism works and immediately locks the driven member to achieve reliable positioning. When the locking mechanism is disengaged, the transmission work is immediately started. Even if the machining accuracy and gravity factors present, the working process will not be affected.

Although the embodiments of the present disclosure have been shown and described, it will be understood by those skilled in the art that variations may be made to these embodiments without departing from the principle and spirit of the present disclosure. The scope of the present disclosure is defined by the appended claims and their equivalents.

What is claimed is:

1. An electric trailer hitch, comprising a fixed member, a trailer hook, a driven member, and a driving member;
the fixed member is fixedly installed on a vehicle body, the driving member is directly or indirectly connected to an actuating device, the driven member is connected to the trailer hook and installed on the fixed member; the driving member is configured to cooperate with the driven member and drive the driven member to rotate; the driving member comprises a transmission part and a locking part, the driven member comprises a transmission part and a locking part;
the transmission parts of the driving member and the driven member and the locking parts of the driving member and the driven member are configured in such a way that, the locking parts engage when the transmission parts are disengaged, and the transmission parts engage when the locking parts are disengaged.

2. The electric trailer hitch according to claim 1, wherein the driving member is an incomplete gear, the transmission part of the driving member is toothed part, and the locking part of the driving member is toothless part.

3. The electric trailer hitch according to claim 2, wherein the driving member and the driven member are respectively provided with transmission guiding features, and the transmission guiding features are configured to facilitate smooth switching between an engagement of the transmission parts and an engagement of the locking parts.

4. The electric trailer hitch according to claim 3, wherein the transmission guiding features are configured to reduce impact when switching between the engagement of the transmission parts and the engagement of the locking parts.

5. The electric trailer hitch according to claim 2, wherein the transmission part and the locking part are located in the same plane; or, the transmission part and the locking part are located in different planes.

6. The electric trailer hitch according to claim 2, wherein the toothed part has a first tooth and/or a last tooth that has a tooth height less than a standard value.

7. The electric trailer hitch according to claim 1, wherein the number of driving members is more than one, and the driving members are distributed circumferentially around the driven member.
